(19) United States
(12) Patent Application Publication
(10) Pub. No.: US 2026/0106509 A1
(43) Pub. Date: Apr. 16, 2026

(54) MOTOR SYSTEM

(71) Applicant: Mazda Motor Corporation, Hiroshima (JP)

(72) Inventors: Yusuke Nakao, Aki-gun (JP); Yoshitomo Takahashi, Aki-gun (JP)

(21) Appl. No.: 19/350,238

(22) Filed: Oct. 6, 2025

(30) Foreign Application Priority Data
Oct. 15, 2024 (JP) 2024-179811

(51) Int. Cl. H02K 5/167; H02K 9/193; B60K 11/04

(52) U.S. Cl. CPC H02K 5/1672; H02K 9/193; B60K 11/04

(57) ABSTRACT

A motor system includes a motor, a slide bearing supporting a rotation shaft of the motor, an oil passage and a refrigerant passage for respectively supplying oil and a refrigerant (a CO₂ refrigerant) into the slide bearing to lubricate the slide bearing, a refrigerant passage for supplying the refrigerant into the motor to cool the motor, and a seal that is supplied with oil and uses the oil to seal a gap between a portion of the rotation shaft extending outward from a housing of the motor. The oil passage supplies the oil to a position on the seal side in an axial direction in the slide bearing, and the refrigerant passage supplies the refrigerant to a position on the rotor side in the axial direction in the slide bearing.

### TECHNICAL FIELD

The present disclosure relates to a motor system that includes a motor and a slide bearing supporting a rotation shaft of the motor.

### BACKGROUND ART

Conventionally, a slide bearing configured to be lubricated by a fluid (a working fluid) such as oil to support a rotation shaft has been known. This type of a technique is described in JP2022-155811A, for example. More specifically, JP2022-155811A discloses a technique of making an auxiliary bearing as a rolling bearing function as a slide bearing (a fluid bearing) by supplying a refrigerant (example of the fluid) to a gap between an inner wheel thereof and the rotation shaft and thereby alleviating an effect of frictional heat that is generated in the auxiliary bearing and the rotation shaft.

### SUMMARY

### TECHNICAL PROBLEM

Here, the present inventors have studied an application of the slide bearing to a rotation shaft of a motor that can rotate at a high rotational frequency (for example, a motor of an electric vehicle), and have obtained the following knowledge in a process of developing this slide bearing.

First, when the rotational frequency of the rotation shaft is relatively low, a load capacity of the slide bearing tends to be low. Meanwhile, when the rotational frequency of the rotation shaft is relatively high, the load capacity of the slide bearing tends to be increased due to a wedge effect and a throttle effect, but loss (friction loss) due to resistance of a fluid tends to also be increased. Accordingly, it can be said that it is desirable to secure the load capacity of the slide bearing in a low rotation range of the rotation shaft and that it is desirable to suppress the load capacity of the slide bearing to reduce the friction loss in a high rotation range of the rotation shaft. Therefore, the present inventors have considered using a fluid having a high viscosity and a fluid having a low viscosity, and mainly apply the fluid having the high viscosity to the slide bearing in the low rotation range of the rotation shaft while mainly applying the fluid having the low viscosity to the slide bearing in the high rotation range of the rotation shaft.

The present inventors have also considered cooling the motor by supplying a predetermined fluid into the motor. In this case, in order to suppress the resistance in the motor, it is desirable to apply the fluid having the low viscosity (such as a refrigerant). Accordingly, the present inventors have considered cooling the motor with the same fluid as the fluid having the low viscosity that is applied to the slide bearing as described above. This is because a system configuration and a control configuration can be simplified. However, not only the fluid having the low viscosity but also the fluid having the high viscosity are applied to the slide bearing described above. Thus, when the fluid having the high viscosity flows from the slide bearing into the motor, stirring resistance is increased in the motor (in particular, a rotor of the motor).

Meanwhile, in general, a seal (e.g., a mechanical seal) is used to seal a gap between the rotation shaft and the housing in the motor. Such a seal seals the gap by using the fluid having the high viscosity (the oil or the like). Accordingly, the present inventors have considered applying the same fluid as the fluid having the high viscosity, which is applied to the slide bearing as described above, to the seal. However, since the fluid having the low viscosity is also applied to this slide bearing, it is desirable to prevent this fluid having the low viscosity from flowing into the seal in order to protect the seal.

The present disclosure has been made to solve the above-described problem of the related art, and an object of the present disclosure is to suppress an increase in stirring resistance in a motor and protect a seal in a motor system that includes the motor cooled by a fluid having a low viscosity, a slide bearing lubricated by using a fluid having a high viscosity, and a seal using the fluid having the high viscosity.

### SOLUTION TO PROBLEM

In order to achieve the above object, the present disclosure provides a motor system including a motor that includes a rotor, a stator, a rotation shaft coupled to the rotor, and a housing accommodating the rotor, the stator, and the rotation shaft; a slide bearing that is lubricated by fluids and supports the rotation shaft of the motor; a first passage and a second passage for supplying, as the fluids, a first fluid and a second fluid having a lower viscosity than the first fluid into the slide bearing; a third passage for supplying the second fluid into the motor to cool the motor; and a seal that is supplied with the first fluid and uses the first fluid to seal a gap between a portion of the rotation shaft extending outward from the housing of the motor and the housing, in which the first passage supplies the first fluid to a position on a seal side in an axial direction of the slide bearing, and the second passage supplies the second fluid to a position on a rotor side in the axial direction of the slide bearing.

According to this configuration, since the motor system supplies the first fluid having a high viscosity from the first passage to a portion on the seal side of the slide bearing, it is possible to prevent the second fluid having the low viscosity from flowing into the seal and thus to protect the seal. In addition, since the motor system supplies the second fluid having the low viscosity from the second passage to a portion on the rotor side in the slide bearing, it is possible to suppress the first fluid having the high viscosity from flowing into the motor and to suppress an increase in stirring resistance in the motor. As has been described above, according to the present disclosure, it is possible to suppress the increase in the stirring resistance in the motor and to protect the seal.

In the present disclosure, preferably, the second passage and the third passage merge at their upstream ends.

According to this configuration, since the refrigerant that lubricates the slide bearing and the refrigerant that cools the motor are of the same system (the second fluid), a configuration of the motor system can be simplified.

In the present disclosure, preferably, the slide bearing further includes a groove portion that is formed on a sliding surface of the slide bearing and extends in a radial direction and a circumferential direction, the groove portion dividing the sliding surface into a plurality of sections in the axial direction; and a discharge hole that is formed in the groove portion to discharge the first and second fluids from the slide bearing, the first passage is configured to supply the first fluid to a section located on the seal side in the axial direction among the plurality of sections, and the second passage is configured to supply the second fluid to a section located on the rotor side in the axial direction among the plurality of sections.

According to this configuration, since the plurality of divided sections (example of the plurality of sections) are formed by the groove portion, and this groove portion is provided with the discharge hole, the fluid in each of the divided sections flows out from the discharge hole through the groove portion that defines each of the divided sections. Thus, it is possible to prevent the fluids from being mixed in adjacent divided sections. As a result, it is possible to reliably prevent the second fluid from flowing into the seal in the vicinity of the divided section (the portion supplied with the first fluid) provided with the first passage, and it is possible to reliably prevent the first fluid from flowing into the rotor in the vicinity of the divided section (the portion supplied with the second fluid) provided with the second passage. Therefore, according to the present disclosure, it is possible to effectively suppress the increase in the stirring resistance in the motor and protect the seal.

In the present disclosure, preferably, the first passage supplies the first fluid to a section located in an end portion on the seal side in the axial direction among the plurality of sections, and the second passage supplies the second fluid to a section located in an end portion on the rotor side in the axial direction among the plurality of sections.

According to this configuration, it is possible to further reliably prevent the second fluid from flowing into the seal and to further reliably prevent the first fluid from flowing into the rotor.

In the present disclosure, preferably, the motor system further includes a fourth passage and a fifth passage for respectively supplying the first fluid and the second fluid to a predetermined section between the section provided with the first passage and the section provided with the second passage among the plurality of sections, a first valve and a second valve respectively provided with the fourth passage and the fifth passage, and a controller that controls opening/closing of each of the first valve and the second valve to switch the fluid to be supplied to the predetermined section between the first fluid and the second fluid.

According to this configuration, since the first fluid and the second fluid are separately supplied from the fourth passage and the fifth passage to a predetermined divided section of the plurality of divided sections, a viscosity of the predetermined division section can be changed appropriately. As a result, it is possible to change an average viscosity of the fluid in the slide bearing and to control a load of the slide bearing. Here, in the invention, the plurality of divided sections are formed by the groove portion, and the fluid is prevented from being mixed in adjacent divided sections by providing the discharge hole to this groove portion. Accordingly, since the viscosity in each of the divided sections does not fluctuate due to mixing of the first fluid and the second fluid, the viscosity of the fluid in each of the divided sections can be accurately adjusted. Thus, it is possible to realize the desired average viscosity in the slide bearing. Therefore, according to the present disclosure, since the load of the slide bearing can be accurately controlled, it is possible to accurately secure the load capacity of the slide bearing and reduce the friction without complicating the control configuration.

In the present disclosure, preferably, based on a rotational frequency of the rotation shaft, the controller selectively executes a control for opening the first valve and closing the second valve to supply the first fluid to the predetermined section and a control for closing the first valve and opening the second valve to supply the second fluid to the predetermined section.

According to this configuration, it is possible to accurately secure the load capacity of the slide bearing and reduce the friction by switching the supply of the first and second fluids to the predetermined divided section according to the rotational frequency of the rotation shaft.

In a preferred example in the present disclosure, the first fluid is oil, and the second fluid is CO₂.

### ADVANTAGEOUS EFFECTS

According to the present disclosure, in the motor system that includes the motor cooled by the fluid having the low viscosity, the slide bearing lubricated by using the fluid having the high viscosity and the fluid having the low viscosity, and the seal using the fluid having the high viscosity, it is possible to suppress the increase in the stirring resistance in the motor and to protect the seal.

### BRIEF DESCRIPTION OF DRAWINGS

FIG. 1 is a schematic configuration view of a vehicle to which a motor system according to an embodiment of the present disclosure is applied.

FIG. 2 is a schematic configuration view of a refrigerant circulation system according to the embodiment of the present disclosure.

FIG. 3 is a schematic configuration view of the motor system according to the embodiment of the present disclosure.

FIGS. 4A and 4B are schematic configuration views of a slide bearing according to the embodiment of the present disclosure.

FIGS. 5A and 5B are views illustrating a load realized by the slide bearing according to the embodiment of the present disclosure.

FIG. 6 is a block diagram illustrating an electrical configuration of the motor system according to the embodiment of the present disclosure.

FIG. 7 is a time chart illustrating control according to the embodiment of the present disclosure.

FIG. 8 is a flowchart illustrating the control according to the embodiment of the present disclosure.

### DETAILED DESCRIPTION

Hereinafter, a motor system according to an embodiment of the present disclosure will be described with reference to the accompanying drawings.

### [Overall Configuration]

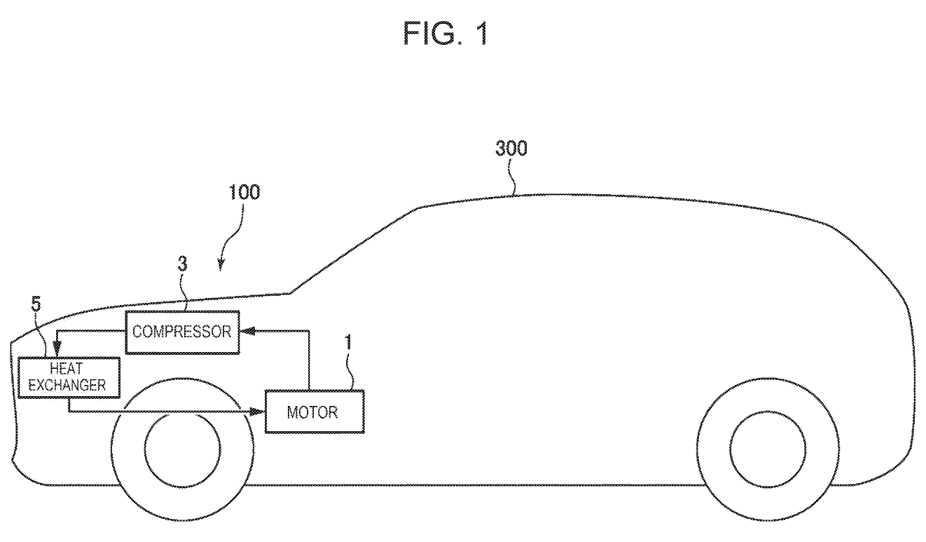

First, FIG. 1 is a schematic configuration view of a vehicle to which the motor system according to the present embodiment is applied.

As illustrated in FIG. 1, a vehicle 300 is an electric vehicle, for example, and includes a refrigerant circulation system 100 that circulates a refrigerant in a refrigeration cycle. This refrigerant circulation system 100 mainly includes a motor (an electric motor) 1 that generates power for driving the vehicle 300, a compressor 3 that compresses the refrigerant to be supplied to the motor 1, and a heat exchanger 5 that includes a condenser, a fan, and the like and cools the refrigerant compressed by the compressor 3.

The refrigerant circulation system 100 circulates a CO₂ refrigerant (hereinafter, also simply referred to as the "refrigerant") as a natural refrigerant. This CO₂ refrigerant contains not only CO₂ but also oil (refrigerant oil) such as polyalkylene glycol (PAG), an additive, and the like. Due to use of such a CO₂ refrigerant, the compressor 3 is configured to compress the refrigerant at an extremely high pressure. The motor 1 uses the refrigerant (typically a refrigerant in a supercritical state), which is thus-compressed by the compressor 3, to lubricate a slide bearing supporting a rotation shaft and to cool a rotor and a stator. In this case, the motor 1 is configured to function as an evaporator in the refrigeration cycle. For example, in the refrigerant circulation system 100, a high-temperature liquid refrigerant is supplied from the compressor 3 to the heat exchanger 5, a low-temperature liquid refrigerant is supplied from the heat exchanger 5 to the motor 1, and a high-temperature gas refrigerant is supplied from the motor 1 to the compressor 3. The refrigerant that is compressed by the compressor 3 may be used for air conditioning by an air conditioner, cooling of a battery, or the like.

### [Configuration of Refrigerant Circulation System]

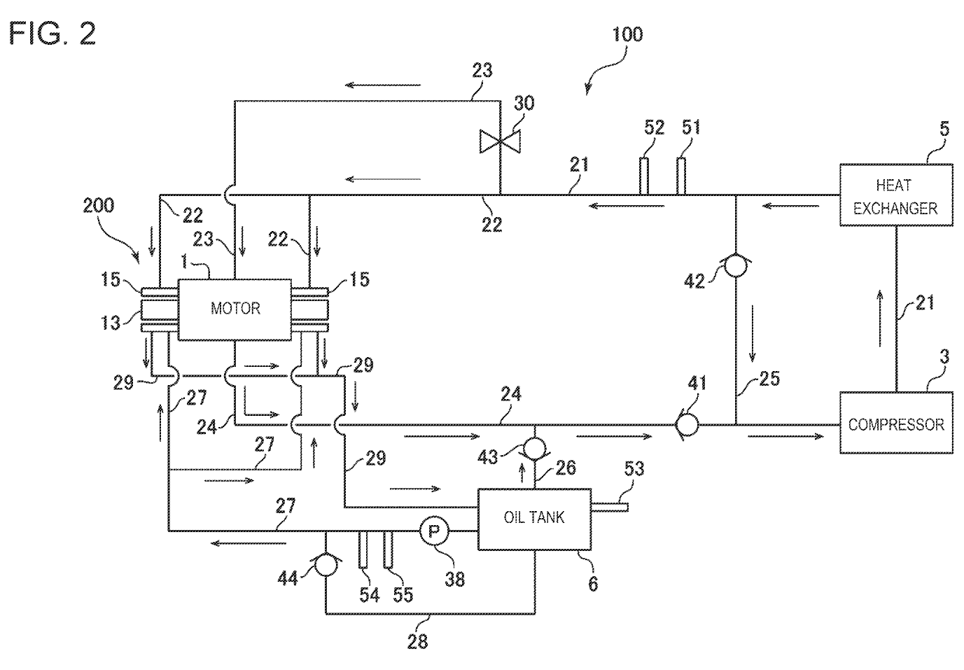

Next, a specific description will be made on the refrigerant circulation system 100 according to the present embodiment with reference to FIG. 2. FIG. 2 is a schematic configuration view of the refrigerant circulation system 100 according to the present embodiment.

As illustrated in FIG. 2, the refrigerant circulation system 100 mainly includes, in addition to the motor 1, the compressor 3, and the heat exchanger 5 described above: a pair of slide bearings 15 that supports a rotation shaft 13 of the motor 1; an oil tank 6 that stores the oil used for lubrication of the slide bearings 15 and the like; refrigerant passages 21 to 26 through each of which the refrigerant (e.g., the CO₂ refrigerant) flows; oil passages 27, 28 through which the oil flows; and a mixed fluid passage 29 through which a mixed fluid of the refrigerant and the oil flows. For example, the oil is the refrigerant oil such as PAG. The motor 1, the slide bearings 15, and the like constitute a motor system 200 (details thereon will be described below).

The refrigerant passage 21 is a passage for supplying the refrigerant from the compressor 3 to the motor 1 and the like via the heat exchanger 5, and is branched into at least one refrigerant passage 22 and the refrigerant passage 23 downstream of the heat exchanger 5. That is, the at least one refrigerant passage 22 and the refrigerant passage 23 merge at their upstream ends. The refrigerant passage 21 is provided with a refrigerant temperature sensor 51 that detects the temperature of the refrigerant and a refrigerant pressure sensor 52 that detects a pressure of the refrigerant.

Hereinafter, description with respect to FIG. 2 will be made to mainly one of the slide bearings 15 as a representative example of the pair. The at least one refrigerant passage 22 is a passage for supplying the refrigerant into the slide bearing 15, and the refrigerant passage 23 is a passage for supplying the refrigerant into the motor 1. These refrigerant passages 22, 23 supply the liquid refrigerant (typically in the supercritical state), which is supplied from the heat exchanger 5 through the refrigerant passage 21, to the slide bearing 15 and the motor 1, respectively. The refrigerant supplied to the slide bearing 15 is used to lubricate the slide bearing 15, and the refrigerant supplied to the motor 1 is used to cool the inside of the motor 1. The refrigerant passage 23 is provided with the flow rate adjustment valve 30 that adjusts the flow rate of the refrigerant.

The refrigerant passage 24 is a passage for supplying the refrigerant discharged from the motor 1 to the compressor 3. A refrigerant passage 25 is connected to the refrigerant passage 24. This refrigerant passage 25 has one end that is connected to the refrigerant passage 21 downstream of the heat exchanger 5 and the other end that is connected to the refrigerant passage 24, and functions to return the refrigerant from the heat exchanger 5 to the compressor 3 without interposing the motor 1, the slide bearing 15, and the like. The refrigerant passages 24, 25 are provided with check valves 41, 42, respectively.

The at least one oil passage 27 is a passage for supplying the oil stored in the oil tank 6 to the slide bearing 15. The oil supplied to the slide bearing 15 is used to lubricate the slide bearing 15 together with the refrigerant described above. The at least one oil passage 27 is provided with: an oil pump 38 for pressure-feeding the oil; an oil temperature sensor 54 that detects a temperature of the oil; and a hydraulic pressure sensor 55 that detects a pressure of the oil. The oil passage 28 for returning the oil in the at least one passage 27 to the oil tank 6 is connected to the at least one oil passage 27. This oil passage 28 is provided with a check valve 44.

The mixed fluid passage 29 is a passage for supplying the mixed fluid of the refrigerant and the oil discharged from the slide bearing 15 to the oil tank 6. The oil tank 6 is configured to separate the oil in the mixed fluid supplied from this mixed fluid passage 29 (gas-liquid separation) and store the separated oil while supplying the rest of the refrigerant (containing a slight amount of the oil) from the refrigerant passage 26 to the refrigerant passage 24 described above. This refrigerant passage 26 is provided with a check valve 43. The oil tank 6 is provided with an oil level sensor 53 that detects a level of the stored oil.

### [Configuration of Motor System]

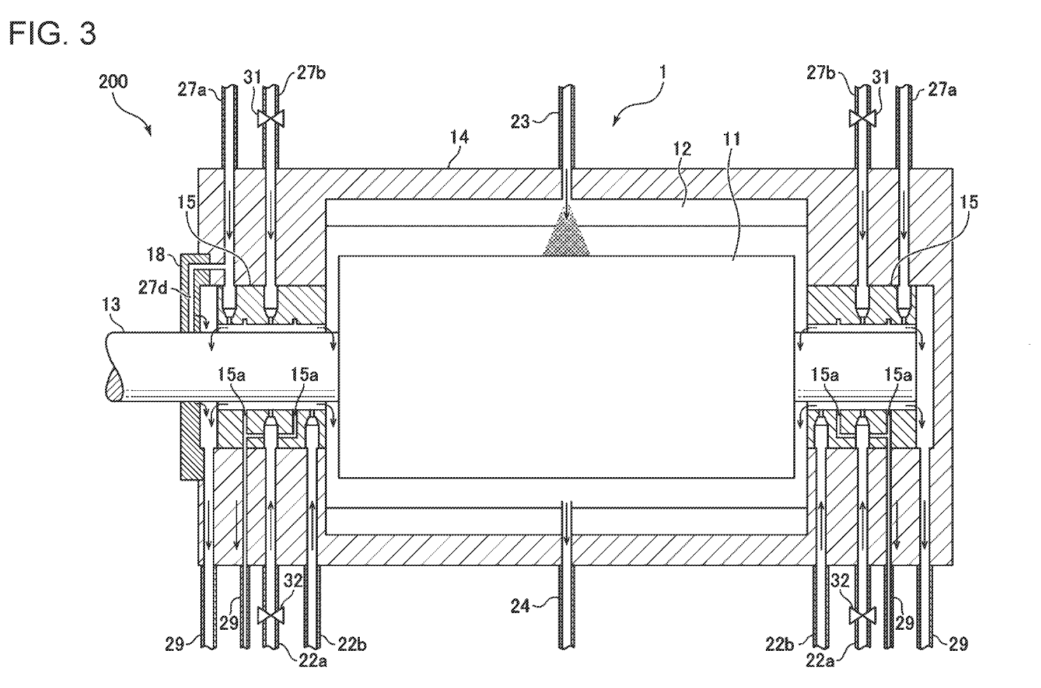

Next, a specific description will be made on a configuration of the motor system 200 according to the present embodiment with reference to FIGS. 3 to 5.

First, FIG. 3 is a schematic configuration view of the motor system 200 according to the present embodiment. More specifically, FIG. 3 is a cross-sectional view in which the motor system 200 is viewed along an axial direction. Here, FIG. 3 illustrates vertical positions of the at least one refrigerant passage 22 and the at least one oil passage 27 in reverse of the positions in FIG. 2 (the same applies to the drawings described below).

As illustrated in FIG. 3, the motor system 200 mainly includes the motor 1 including a rotor 11, a stator 12, the rotation shaft 13 coupled to the rotor 11 and having one end connected to a transaxle (not illustrated) of the vehicle 300 or the like, and a housing 14 that accommodates these rotor 11, stator 12, and rotation shaft 13, and includes the pair of the slide bearings 15 that supports the rotation shaft 13 of the motor 1. This pair of the slide bearings 15 is also accommodated in the housing 14 of the motor 1.

As described above, in the motor 1, the refrigerant (the liquid refrigerant) is supplied from the refrigerant passage 23 to the rotor 11 and the stator 12. The refrigerant that is supplied to the motor 1, just as described, is used to cool the rotor 11 and the stator 12, in particular, to cool a coil (not illustrated) in the stator 12. In this case, since the refrigerant exchanges heat with the stator 12 and the like at a relatively high temperature (at this time, the refrigerant is evaporated in the coil of the stator 12), the function of the evaporator in the refrigeration cycle is realized. Then, the refrigerant used for cooling in the motor 1 is discharged from the refrigerant passage 24.

Subsequently, the pair of the slide bearings 15 are arranged to oppose each other symmetrically (bilaterally symmetrically) across the rotor 11 in the axial direction. Each of the paired slide bearings 15 is supplied with the oil from two of the oil passages 27 (27a, 27b) and supplied with the refrigerant from two of the refrigerant passages 22 (22a, 22b). The refrigerant and oil are supplied to a gap between an inner peripheral surface of each of the slide bearings 15 and an outer peripheral surface of the rotation shaft 13 of the motor 1, and are thereby used for lubrication when the slide bearings 15 support the rotation shaft 13. The refrigerant and the oil used to lubricate the slide bearings 15 are discharged together as the mixed fluid from the mixed fluid passage 29. The refrigerant used to lubricate the slide bearings 15, in particular, the refrigerant used in an end portion of the slide bearing 15 located on the rotor 11 side (that is, a side of the slide bearing 15 oriented toward the rotor 11) flows into a space of the housing 14 where the rotor 11 and the stator 12 are accommodated, and is discharged from the refrigerant passage 24 together with the refrigerant used to cool the motor 1.

More specifically, the oil passages 27a, 27b supply the oil to different portions (two portions) of each of the slide bearings 15 along the axial direction, and the refrigerant passages 22a, 22b supply the refrigerant to different portions (two portions) of each of the slide bearings 15 along the axial direction. More specifically, the oil passage 27a is configured to supply the oil to a position on an opposite side from the rotor 11 in the axial direction in the sliding bearing 15 (the seal 18 side for one of the paired slide bearings 15, that is, a side of the slide bearing 15 oriented toward the seal 18 rather than toward the rotor 11), and the refrigerant passage 22b is configured to supply the refrigerant to a position on the rotor 11 side in the axial direction in the slide bearing 15. Meanwhile, the oil passage 27b and the refrigerant passage 22a are configured to respectively supply the oil and the refrigerant to a position that is located between the supply portions of the oil passage 27a and the refrigerant passage 22b in the axial direction. In this case, the oil passage 27b and the refrigerant passage 22a respectively supply the oil and the refrigerant to substantially the same portions in the axial direction, that is, the portion where the oil passage 27b supplies the oil and the portion where the refrigerant passage 22a supply the refrigerant in the axial direction are substantially the same. Meanwhile, the refrigerant is not supplied to the portion where the oil passage 27a supplies the oil in the axial direction, and the oil is not supplied to the portion where the refrigerant passage 22b supplies the refrigerant in the axial direction.

In addition, the motor system 200 includes: an oil bearing valve 31 that is provided in the oil passage 27b and can switch supply/blockage of the oil by opening/closing; and a refrigerant bearing valve 32 that is provided in the refrigerant passage 22a and can switch supply/blockage of the refrigerant by opening/closing.

In addition, the motor system 200 further includes a seal 18 for sealing a side of the rotation shaft 13 connected to the transaxle or the like (a side provided with the slide bearing 15 and illustrated on the left in FIG. 3). This seal 18 is provided to prevent leakage of the fluid from a gap between the housing 14 and a portion of the rotation shaft 13 extending outward from the housing 14. The seal 18 is configured as a mechanical seal that is supplied with the oil from an oil passage 27d connected to the oil passage 27a described above and uses this oil to prevent the leakage of the fluid.

Here, the oil is an example of a "first fluid" in the present disclosure, and the refrigerant (the CO₂ refrigerant) is an example of a "second fluid" in the present disclosure. In addition, the oil passage 27a, the refrigerant passage 22b, and the refrigerant passage 23 are examples of a "first passage", a "second passage," and a "third passage" in the present disclosure, respectively. The oil passage 27b and the refrigerant passage 22a are examples of a "fourth passage" and a "fifth passage" in the present disclosure, respectively. The oil bearing valve 31 and the refrigerant bearing valve 32 are examples of a "first valve" and a "second valve" in the present disclosure.

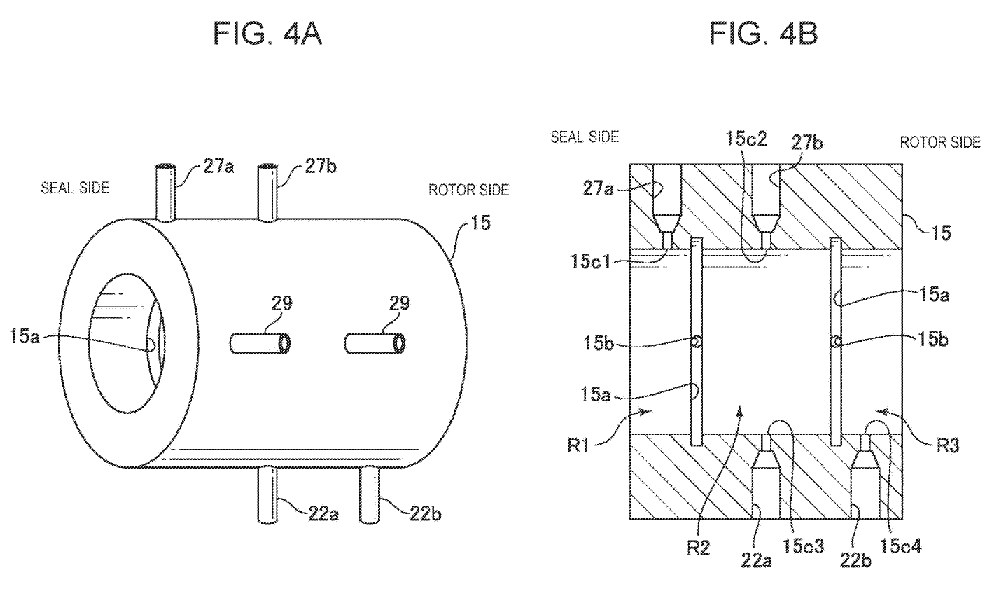

Next, FIGS. 4A and 4B include schematic configuration views for more specifically illustrating the slide bearing 15 according to the present embodiment. More specifically, FIG. 4A is a perspective view of one of the paired slide bearings 15 (the slide bearing 15 illustrated on the left in FIG. 3, that is, the slide bearing 15 on the side where the seal 18 is provided), and FIG. 4B is a cross-sectional view in which the one slide bearing 15 is viewed along the axial direction.

As illustrated in FIGS. 4A and 4B, in particular FIG. 4B, each of the slide bearings 15 has two annular groove portions 15a that are formed on a sliding surface (the inner peripheral surface) thereof, extend in a radial direction, and extend over an entire circumference in a circumferential direction. These two groove portions 15a of the slide bearing 15 divide the sliding surface of the slide bearing 15 into three divided sections R1 to R3 in the axial direction. The divided sections R1, R3 in both end portions have substantially the same length along the axial direction. However, the divided section R2 in an intermediate portion sandwiched between these divided sections R1, R3 is longer along the axial direction than the divided sections R1, R3.

The slide bearing 15 further includes a discharge hole 15b that is formed in each of the two groove portions 15a to discharge the refrigerant and the oil from the slide bearing 15, supply holes 15c1, 15c2 for respectively supplying the oil to the divided sections R1, R2, and supply holes 15c3, 15c4 for respectively supplying the refrigerant to the divided sections R2, R3. The discharge hole 15b communicates with the mixed fluid passage 29, the supply holes 15c1, 15c2 communicate with the oil passages 27a, 27b, respectively, and the supply holes 15c3, 15c4 communicate with the refrigerant passages 22a, 22b, respectively. In this case, the oil passage 27a is configured to supply the oil to the divided section R1 in an end portion on the seal 18 side in the axial direction among the divided sections R1 to R3, and the refrigerant passage 22b is configured to supply the refrigerant to the divided section R3 in an end portion on the rotor 11 side in the axial direction among the divided sections R1 to R3. The two or more discharge holes 15b may be provided on the same groove portion 15a.

According to such a slide bearing 15, the three divided sections R1 to R3 are formed in the axial direction by the two groove portions 15a, and these groove portions 15a are provided with the discharge holes 15b. Thus, the fluid (the oil or the refrigerant) in each of the divided sections R1 to R3 flows out from the respective discharge hole 15b through respective one of the groove portions 15a that define the divided sections R1 to R3. In this way, it is possible to prevent the fluid from moving back and forth between the adjacent two of the divided sections R1 to R3 and thereby prevent the fluid from being mixed in the divided sections R1 to R3. This is because, since a size (for example, in an order of mm) of the groove portion 15a is significantly larger than a gap (for example, in an order of μm) between the rotation shaft 13 of the motor 1 and the slide bearing 15, the fluid in each of the divided sections R1 to R3 flows into the respective groove portion 15a without flowing to the adjacent divided section by passing the groove portion 15a.

In particular, according to the present embodiment, since it is possible to prevent the oil and the refrigerant from being mixed in each of the divided sections R1 to R3 as described above, it is possible to prevent the refrigerant from flowing into the seal 18 side that is adjacent to the divided section R1 (the portion supplied with the oil only), and it is thus possible to protect the seal 18. In addition, it is possible to prevent the oil from flowing into the rotor 11 side that is adjacent to the divided section R3 (the portion supplied with the refrigerant only), and it is possible to suppress an increase in stirring resistance in the motor 1.

Here, only the oil is supplied to the divided section R1 through the oil passage 27a and the supply hole 15c1, and only the refrigerant is supplied to the divided section R3 through the refrigerant passage 22b and the supply hole 15c4. Meanwhile, the oil is supplied to the divided section R2 through the oil passage 27b and the supply hole 15c2, and the refrigerant is supplied through the refrigerant passage 22a and the supply hole 15c3. As described above, the oil passage 27b and the refrigerant passage 22a applied to such a divided section R2 are provided with the oil bearing valve 31 and the refrigerant bearing valve 32, respectively (FIG. 3). In the present embodiment, only one of the oil or the refrigerant is supplied to the divided section R2 (that is, both the oil and the refrigerant are not supplied at the same time) by opening one of the oil bearing valve 31 and the refrigerant bearing valve 32 and closing the other thereof, and open/closed states of such an oil bearing valve 31 and a refrigerant bearing valve 32 are changed. In this way, the fluid to be supplied to the divided section R2 is switched between the oil and the refrigerant.

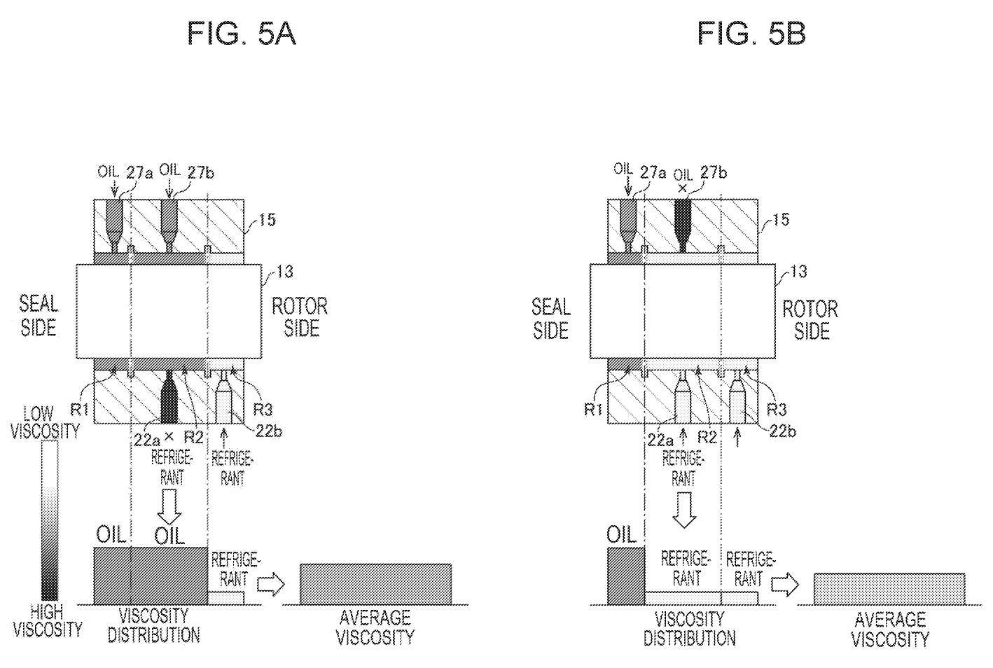

Next, FIG. 5 includes views illustrating a load realized by the slide bearing 15 according to the present embodiment. More specifically, FIGS. 5A and 5B illustrate a supply state of the oil or the refrigerant in one of the paired slide bearings 15 (the slide bearing 15 illustrated on the left in FIG. 3, that is, the slide bearing 15 on the side where the seal 18 is provided) in upper portions thereof. FIGS. 5A and 5B illustrate a viscosity distribution of the fluid in the gap between the rotation shaft 13 of the motor 1 and the slide bearing 15, and an average viscosity thereof in lower portions thereof. In FIGS. 5A and 5B, a magnitude of the viscosity of the fluid is indicated by shading (the oil having a high viscosity is indicated by a dark shade, and the refrigerant having a low viscosity is indicated by a light shade). In addition, "↑" or "↓" indicates the supply of the corresponding fluid, and "x" indicates stopping of the supply of the corresponding fluid.

FIG. 5A illustrates a case where the oil is supplied to the divided sections R1, R2 while the refrigerant is supplied to the divided section R3. In this case, it is not the refrigerant but the oil that is applied as the fluid that is supplied to the divided section R2 (the fluids supplied to the divided sections R1, R3 are limited to the oil and the refrigerant in this embodiment). At this time, the oil bearing valve 31 in the oil passage 27b is opened while the refrigerant bearing valve 32 in the refrigerant passage 22a is closed. In the case illustrated in FIG. 5A, the viscosity (the viscosity of the oil) in portions as the divided sections R1, R2 are higher than the viscosity (the viscosity of the refrigerant) in a portion as the divided section R3. In this case, the average viscosity in the viscosity distribution is relatively high (lower right of FIG. 5A). As a result, the load applied by the slide bearing 15 becomes relatively large.

FIG. 5B illustrates a case where the oil is supplied to the divided section R1 while the refrigerant is supplied to the divided sections R2, R3. In this case, it is not the oil but the refrigerant that is applied as the fluid to be supplied to the divided section R2. At this time, the oil bearing valve 31 in the oil passage 27b is closed while the refrigerant bearing valve 32 in the refrigerant passage 22a is opened. In the case illustrated in FIG. 5B, the viscosity (the viscosity of the refrigerant) of the divided sections R2, R3 are lower than the viscosity (the viscosity of the oil) of the divided section R1. In this case, the average viscosity in the viscosity distribution (lower right of FIG. 5B) is lower than the average viscosity in the case of FIG. 5A. As a result, the load applied by the slide bearing 15 is relatively small.

According to such a present embodiment, the load applied by the slide bearing 15 can be switched by switching the fluid supplied to the divided section R2 between the oil and the refrigerant. In this way, the relatively large load as illustrated in FIG. 5A can be applied in a low rotation range of the rotation shaft 13 of the motor 1, and the relatively small load as illustrated in FIG. 5B can be applied in a high rotation range of the rotation shaft 13 of the motor 1. Here, in the present embodiment, it is possible to prevent the fluid from being mixed in adjacent sections of the divided sections R1 to R3 by forming the divided sections R1 to R3 by the groove portions 15a. Accordingly, when both the oil and the refrigerant are applied in the slide bearing 15, the oil and the refrigerant are not mixed in adjacent sections of the divided sections R1 to R3. Thus, it is possible to reliably realize the desired average viscosity by setting the viscosity of the fluid in each of the divided sections R1 to R3 to be substantially constant (in other words, the viscosity in each of the divided sections R1 to R3 does not fluctuate by mixing of the oil and the refrigerant). As a result, according to the present embodiment, it is possible to accurately control the load applied by the slide bearing 15.

The average viscosity in the slide bearing 15 varies according to the length along the axial direction of the divided sections R1 to R3. Accordingly, it is preferable to set the length along the axial direction of each of the divided sections R1 to R3 according to the desired average viscosity to be realized.

### [Electrical Configuration]

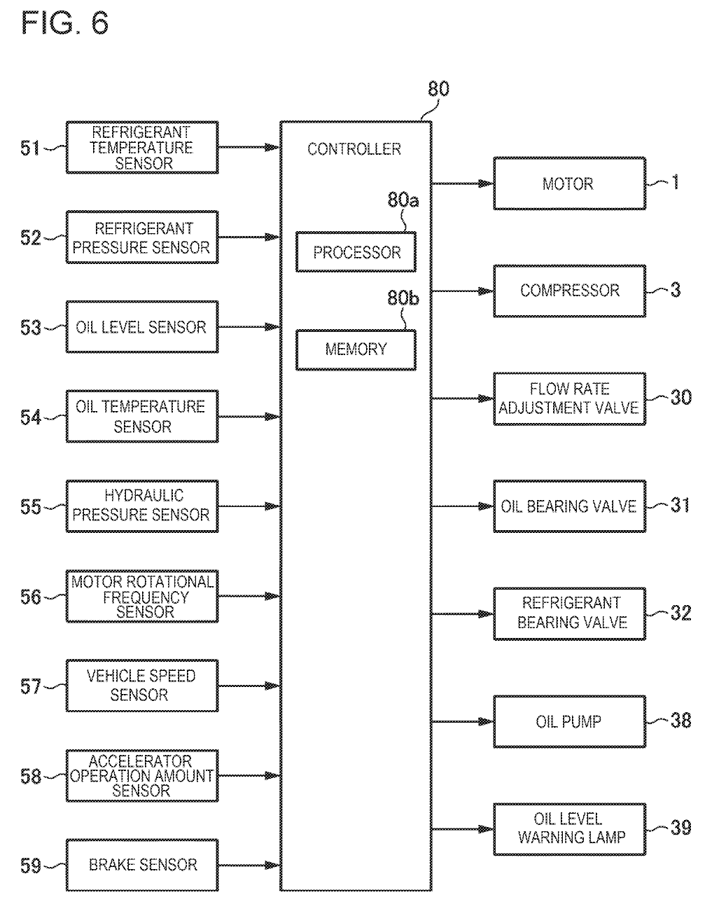

Next, an electrical configuration of the motor system 200 according to the present embodiment will be described with reference to FIG. 6. FIG. 6 is a block diagram illustrating the electrical configuration of the motor system 200 according to the present embodiment.

As illustrated in FIG. 6, the motor system 200 includes a controller 80 configured to execute various types of control in the system. The controller 80 is configured with a computer that includes one or more processors 80a (typically Central Processing Units (CPUs)), and memory 80b, such as Read-Only Memory (ROM) or Random Access Memory (RAM), that stores various programs (including a basic control program such as an Operating System (OS) and an application program activated on the OS to implement a particular function) interpretively executed on the processor 80a and various types of data.

The motor system 200 includes, in addition to the sensors 51 to 55 described above (see FIG. 2): a motor rotational frequency sensor 56 that detects a motor rotational frequency of the motor 1 (rotational frequencies of the rotor 11 and the rotation shaft 13 being equivalent to the rotational frequency); a vehicle speed sensor 57 that detects a speed (a vehicle speed) of the vehicle 300; an accelerator operation amount sensor 58 that detects an accelerator operation amount corresponding to a depression amount of an accelerator pedal in the vehicle 300; and a brake sensor 59 that detects an operation of a brake pedal in the vehicle 300.

The controller 80 supplies a control signal to the motor 1, the compressor 3, the flow rate adjustment valve 30, the oil bearing valve 31, the refrigerant bearing valve 32, the oil pump 38, and an oil level warning lamp 39 on the basis of detection signals from these sensors 51 to 59. The oil level warning lamp 39 is a lamp for warning that the level of the oil stored in the oil tank 6 (detected by the oil level sensor 53) is lower than a predetermined value.

In the present embodiment, the controller 80 mainly controls opening/closing of each of the oil bearing valve 31 and the refrigerant bearing valve 32 in order to switch the fluid supplied to the divided section R2 of the slide bearing 15 between the oil and the refrigerant on the basis of the motor rotational frequency detected by the motor rotational frequency sensor 56, or the like. More specifically, based on the motor rotational frequency, the controller 80 selectively executes control for opening the oil bearing valve 31 and closing the refrigerant bearing valve 32 to supply the oil to the divided section R2, and control for closing the oil bearing valve 31 and opening the refrigerant bearing valve 32 to supply the refrigerant to the divided section R2.

### [Control Method]

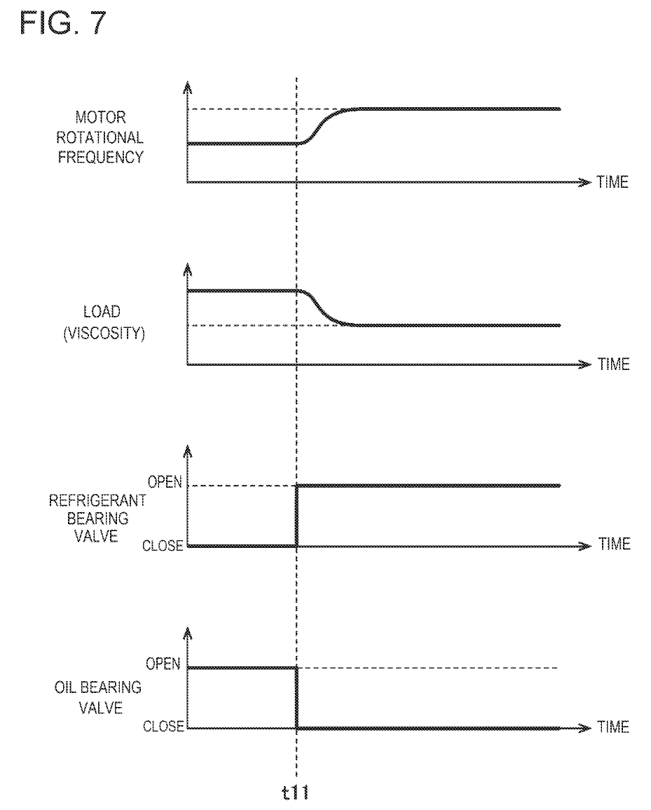

Next, a specific description will be made on the control executed by the controller 80 of the motor system 200 in the present embodiment. First, a flow of the control executed by the controller 80 in the present embodiment will be described with reference to FIG. 7. FIG. 7 is a time chart illustrating the control according to the present embodiment. FIG. 7 illustrates, in an order from the top, temporal changes in the motor rotational frequency, the load applied by the slide bearing 15 (corresponding to the viscosity of the fluid in the slide bearing 15), opening/closing of the refrigerant bearing valve 32, and opening/closing of the oil bearing valve 31.

As illustrated in FIG. 7, the motor rotational frequency is increased at time t11. As a result, the load to be realized by the slide bearing 15 (hereinafter, referred to as a "required load") that is determined according to the motor rotational frequency is reduced. Accordingly, at such time t11, the controller 80 executes control for closing the oil bearing valve 31 and opening the refrigerant bearing valve 32 to switch the fluid supplied to the divided section R2 of the slide bearing 15 from the oil to the refrigerant in order to suppress the load of the slide bearing 15.

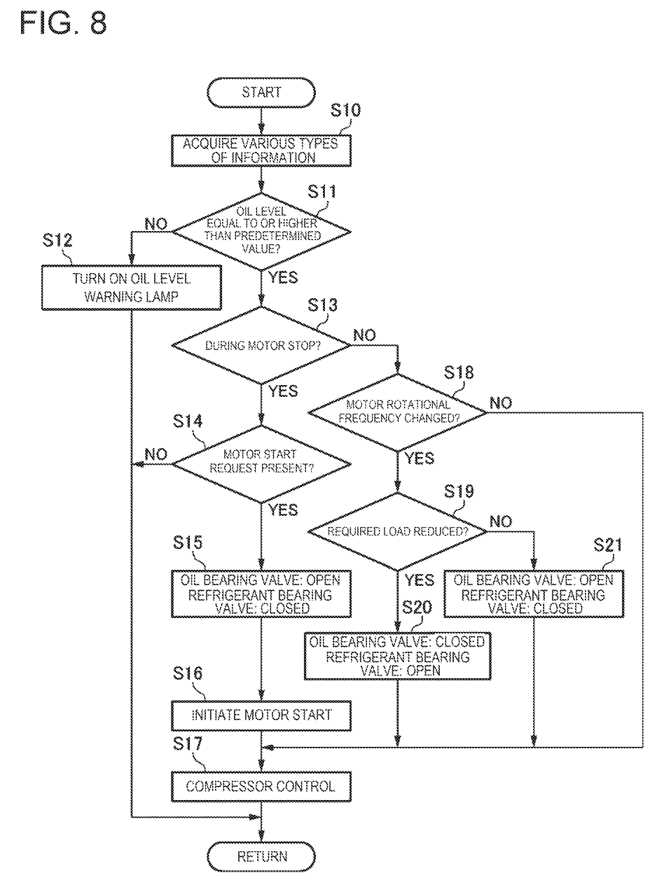

Next, a description will be made on a flowchart illustrating specific control according to the present embodiment with reference to FIG. 8. This flow is repeatedly executed by the controller 80 in a predetermined cycle. In detail, the processor 80a in the controller 80 reads the program stored in the memory 80b to execute the program, and thereby realizes the control for this flow.

First, in step S10, the controller 80 acquires various types of information such as the detection values detected by the sensors 51 to 59 (FIG. 6) described above. Then, the processing proceeds to step S11, and the controller 80 determines whether the oil level detected by the oil level sensor 53 is equal to or higher than the predetermined value. As a result, if the controller 80 does not determine that the oil level is equal to or higher than the predetermined value (step S11: No), that is, if the oil level is lower than the predetermined value, the processing proceeds to step S12, and the oil level warning lamp 39 is turned on.

On the other hand, if the controller 80 determines that the oil level is equal to or higher than the predetermined value in step S11 (step S11: Yes), the processing proceeds to step S13. In step S13, the controller 80 determines whether the motor 1 is stopped on the basis of the motor rotational frequency detected by the motor rotational frequency sensor 56, and the like. As a result, if the controller 80 determines that the motor 1 is stopped (step S13: Yes), the processing proceeds to step S14, and it is determined whether there is a motor start request on the basis of a start switch of the vehicle 300, the accelerator operation amount detected by the accelerator operation amount sensor 58, or the like. As a result, if the controller 80 determines that there is the motor start request (step S14: Yes), the processing proceeds to step S15. On the other hand, if it does not determine that there is the motor start request (step S14: No), the control according to this flow is terminated.

In step S15, the controller 80 opens the oil bearing valve 31 and closes the refrigerant bearing valve 32 to supply the oil to the divided section R2 of the slide bearing 15 in order to secure the load of the slide bearing 15 before the motor 1 is started. Then, the processing proceeds to step S16 to start the motor 1 and then proceeds to step S17, and the controller 80 executes a control for adjusting the rotational frequency of the compressor 3.

On the other hand, if the controller 80 does not determine that the motor 1 is stopped in step S13 (step S13: No), that is, if the motor 1 is already in operation, the processing proceeds to step S18. In step S18, the controller 80 calculates a motor target rotational frequency on the basis of the accelerator operation amount detected by the accelerator operation amount sensor 58, or the like, and determines whether this motor target rotational frequency is changed. As a result, if the controller 80 determines that the motor target rotational frequency is changed (step S18: Yes), the processing proceeds to step S19. On the other hand, if it does not determine that the motor target rotational frequency is changed (step S18: No), the processing proceeds to step S17 without the processing in steps S19 to S21 being executed.

In step S19, the controller 80 calculates the required load of the slide bearing 15 on the basis of the motor rotational frequency detected by the motor rotational frequency sensor 56, or the like, and determines whether this required load is reduced. In this case, the required load tends to be reduced as the motor rotational frequency is increased. As a result of step S19, if the controller 80 determines that the required load is reduced (step S19: Yes), the processing proceeds to step S20. In this case, since the motor rotational frequency is increased, the controller 80 closes the oil bearing valve 31 and opens the refrigerant bearing valve 32 to supply the refrigerant to the divided section R2 of the slide bearing 15 in order to suppress the load of the slide bearing 15. Then, the processing proceeds to step S17 described above.

On the other hand, if the controller 80 does not determine that the required load is reduced (step S19: No), that is, if the required load is increased, the processing proceeds to step S21. In this case, since the motor rotational frequency is reduced, the controller 80 opens the oil bearing valve 31 and closes the refrigerant bearing valve 32 to supply the oil to the divided section R2 of the slide bearing 15 in order to secure the load of the slide bearing 15. Then, the processing proceeds to step S17 described above.

Here, in step S19, the controller 80 determines whether the required load of the slide bearing 15 is reduced. However, in another example, instead of making such a determination, it may be determined whether the motor rotational frequency is equal to or higher than the predetermined value.

### [Operation and Effects]

Next, operation and effects of the motor system 200 according to the present embodiment will be described.

In the present embodiment, the motor system 200 includes: the motor 1 including the rotor 11, the stator 12, the rotation shaft 13 coupled to the rotor 11, and the housing 14 accommodating the rotor 11, the stator 12, and the rotation shaft 13; the slide bearing 15 that is lubricated by the fluids and supports the rotation shaft 13 of the motor 1; the oil passage 27a and the refrigerant passage 22b for respectively supplying the oil and the CO₂ refrigerant into the slide bearing 15 in order to lubricate the slide bearing 15; the refrigerant passage 23 for supplying the refrigerant into the motor 1 to cool the motor 1; and the seal 18 that is supplied with the oil and seals the gap between the portion of the rotation shaft 13 extending outward from the housing 14 of the motor 1 and the housing 14 by using the oil. The oil passage 27a is configured to supply the oil to the position of the slide bearing 15 located on the seal 18 side in the axial direction, and the refrigerant passage 22b for supplying the refrigerant to the position of the slide bearing 15 located on the rotor 11 side in the axial direction.

According to such a present embodiment, since the oil is supplied from the oil passage 27a to the portion on the seal 18 side in the slide bearing 15, it is possible to prevent the refrigerant from flowing into the seal 18, and it is possible to protect the seal 18. In addition, since the refrigerant is supplied from the refrigerant passage 22b to the portion on the rotor 11 side of the slide bearing 15, it is possible to suppress the oil from flowing into the motor 1, and it is possible to suppress the increase in the stirring resistance in the motor 1. As has been described above, according to the present embodiment, it is possible to suppress the increase in the stirring resistance in the motor 1 and to protect the seal 18.

In addition, according to the present embodiment, the refrigerant passage 22b and the refrigerant passage 23 merge at their upstream ends. As a result, since the refrigerant that lubricates the slide bearing 15 and the refrigerant that cools the motor 1 are of the same system (the refrigerant), the configuration of the motor system 200 can be simplified.

Furthermore, according to the present embodiment, the slide bearing 15 has the two groove portions 15a formed on the sliding surface of the slide bearing 15 and extending in the radial direction and the circumferential direction, and the sliding surface of the slide bearing 15 is divided into the plurality of divided sections R1 to R3 in the axial direction by these groove portions 15a. The slide bearing 15 also includes the discharge hole 15b formed in the groove portions 15a for discharging the oil and the refrigerant from the slide bearing 15, the oil passage 27a is configured to supply the oil to the divided section R1 located on the seal 18 side in the axial direction among the divided sections R1 to R3 (more specifically, located in the end portion on the seal 18 side), and the refrigerant passage 22b is configured to supply the refrigerant to the divided section R3 located on the rotor 11 side in the axial direction (more specifically, located in the end portion on the rotor 11 side) among the divided sections R1 to R3.

According to such a present embodiment, since the divided sections R1 to R3 are formed by the groove portions 15a, and these groove portions 15a are each provided with the discharge hole 15b, the fluid in each of the divided sections R1 to R3 flows out from the respective discharge hole 15b through respective one of the groove portions 15a that define the divided sections R1 to R3. Thus, it is possible to prevent the fluids from being mixed in an adjacent two of the divided sections R1 to R3. As a result, it is possible to reliably prevent the refrigerant from flowing into the seal 18 side that is adjacent to the divided section R1 (the portion supplied with the oil only), and it is possible to reliably prevent the oil from flowing into the rotor 11 side that is adjacent to the divided section R3 (the portion supplied with the refrigerant only). Therefore, according to the present embodiment, it is possible to further effectively suppress the increase in the stirring resistance in the motor 1 and protect the seal 18.

According to the present embodiment, the motor system 200 further includes: the oil passage 27b and the refrigerant passage 22a for supplying the oil and the refrigerant to the divided section R2 between the divided section R1 provided with the oil passage 27a and the divided section R3 provided with the refrigerant passage 22b of the divided sections R1 to R3; the oil bearing valve 31 and the refrigerant bearing valve 32 respectively provided to the oil passage 27b and the refrigerant passage 22a; and the controller 80 configured to control opening/closing of each of the oil bearing valve 31 and the refrigerant bearing valve 32 to switch the fluid supplied to the divided section R2 between the oil and the refrigerant.

According to such a present embodiment, since the oil and the refrigerant are separately supplied from the oil passage 27b and the refrigerant passage 22a to the divided section R2 of the divided sections R1 to R3, it is possible to appropriately change the viscosity in the divided section R2. As a result, it is possible to change the average viscosity of the fluid in the slide bearing 15 and to control the load of the slide bearing 15. Here, in the present embodiment, it is possible to prevent the fluid from being mixed in adjacent two of the divided sections R1 to R3 by forming the divided sections R1 to R3 by the groove portions 15a and providing the discharge hole 15b to each of these groove portions 15a. Accordingly, since the viscosity in each of the divided sections R1 to R3 does not fluctuate due to mixing of the oil and the refrigerant, the viscosity of the fluid in each of the divided sections R1 to R3 can be accurately adjusted. Thus, it is possible to realize the desired average viscosity in the slide bearing 15. Therefore, according to the present embodiment, since the load of the slide bearing 15 can be accurately controlled, it is possible to accurately secure the load capacity of the slide bearing 15 and reduce the friction without complicating the control configuration.

In addition, according to the present embodiment, based on the motor rotational frequency (including the required load that is set on the basis of the motor rotational frequency), the controller 80 selectively executes the control for opening the oil bearing valve 31 and closing the refrigerant bearing valve 32 to supply the oil to the divided section R2, and the control for closing the oil bearing valve 31 and opening the refrigerant bearing valve 32 to supply the refrigerant to the divided section R2. In this way, it is possible to secure the load capacity of the slide bearing 15 in the low rotation range while it is possible to reduce the friction of the slide bearing 15 in the high rotation range.

### [Modified Examples]

In the above-described embodiment, when the motor rotational frequency becomes relatively high, the controller 80 stops the supply of the oil to the divided section R2 and supplies the refrigerant to the divided section R2 in order to reduce the friction (reduce the lubrication resistance) by the oil in the slide bearing 15 (FIGS. 7 and 8). However, it can be said that the refrigerant has little effect on the load capacity even when the refrigerant is supplied to the divided section R2, just as described (due to the low load capacity of the refrigerant). In this case, it is considered that the load capacity can be sufficiently secured by the oil and the refrigerant supplied to the divided sections R1, R3, in particular, the oil. Meanwhile, it can be said that wasteful energy consumption occurs when the refrigerant is prepared to be supplied to the divided section R2. From the above, it can be said that the refrigerant does not have to be supplied to the divided section R2 when the motor rotational frequency is relatively high.

Accordingly, in the modified example, after the supply of the oil to the divided section R2 is stopped, the refrigerant is not supplied to the divided section R2. In this case, there is a problem that the oil remains in the divided section R2 after the stop of the supply of the oil to the divided section R2, causing drag resistance from this oil. Accordingly, in the first modified example, after the supply of the oil to the divided section R2 is stopped, the controller 80 supplies the refrigerant to the divided section R2 for a predetermined time and thereby cleans the oil remaining in the divided section R2 with the refrigerant (that is, cleans an oil lubrication surface). Then, in the modified example, after supplying the refrigerant to the divided section R2 for a predetermined time, the controller 80 stops the supply of the refrigerant to the divided section R2.

According to such a modified example, after the supply of the oil to the divided section R2 of the slide bearing 15 is stopped, the refrigerant is supplied to the divided section R2 to clean out the oil remaining in the divided section R2 with the refrigerant. Thus, it is possible to suppress the resistance caused by drag from the oil. In addition, according to the modified example, the supply of the refrigerant to the divided section R2 is stopped after the oil remaining in the divided section R2 is cleaned with the refrigerant, just as described. Thus, it is possible to suppress the wasteful energy consumption of preparing the refrigerant for the divided section R2.

Furthermore, in the embodiment described above, the three divided sections R1 to R3 are formed in the slide bearing 15 by the two groove portions 15a. In the modified example described above, two divided sections may be formed by the single groove portion 15a, or three or more divided sections may be formed by the four or more groove portions 15a.

In addition, in the embodiment described above, the oil and CO₂ refrigerant are used as examples of the fluids having the different viscosities (the first and second fluids). However, any of various fluids other than the oil and CO₂ may be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1: motor

3: compressor

5: heat exchanger

6: oil tank

11: rotor

12: stator

13: rotation shaft

15: slide bearing

15a: groove portion

15b: discharge hole

15c1 to 15c4: supply hole

21 to 26: refrigerant passage

27, 28: oil passage

29: mixed fluid passage

80: controller

100: refrigerant circulation system

200: motor system

300: vehicle

R1 to R3: divided section

What is claimed is:

1. A motor system comprising:
a motor that includes a rotor, a stator, a rotation shaft coupled to the rotor, and a housing accommodating the rotor, the stator, and the rotation shaft;
a slide bearing that is lubricated by fluids and supports the rotation shaft of the motor;
a first passage and a second passage for supplying, as the fluids, a first fluid and a second fluid having a lower viscosity than the first fluid into the slide bearing;
a third passage for supplying the second fluid into the motor to cool the motor; and
a seal that is supplied with the first fluid and uses the first fluid to seal a gap between a portion of the rotation shaft extending outward from the housing of the motor and the housing, wherein
the first passage supplies the first fluid to a position on a seal side in an axial direction of the slide bearing, and
the second passage supplies the second fluid to a position on a rotor side in the axial direction of the slide bearing.

2. The motor system according to claim 1, wherein the second passage and the third passage merge at their upstream ends.

3. The motor system according to claim 1, wherein
the slide bearing further includes:
a groove portion that is formed on a sliding surface of the slide bearing and extends in a radial direction and a circumferential direction, the groove portion dividing the sliding surface into a plurality of sections in the axial direction; and
a discharge hole that is formed in the groove portion to discharge the first and second fluids from the slide bearing,
the first passage supplies the first fluid to a section located on the seal side in the axial direction among the plurality of sections, and
the second passage supplies the second fluid to a section located on the rotor side in the axial direction among the plurality of sections.

4. The motor system according to claim 3, wherein
the first passage supplies the first fluid to a section located in an end portion on the seal side in the axial direction among the plurality of sections, and
the second passage supplies the second fluid to a section located in an end portion on the rotor side in the axial direction among the plurality of sections.

5. The motor system according to claim 3, further comprising:
a fourth passage and a fifth passage for respectively supplying the first fluid and the second fluid to a predetermined section between the section provided with the first passage and the section provided with the second passage among the plurality of sections;
a first valve and a second valve respectively provided with the fourth passage and the fifth passage; and
a controller that controls opening/closing of each of the first valve and the second valve to switch the fluid to be supplied to the predetermined section between the first fluid and the second fluid.

6. The motor system according to claim 5, wherein based on a rotational frequency of the rotation shaft, the controller selectively executes a control for opening the first valve and closing the second valve to supply the first fluid to the predetermined section and a control for closing the first valve and opening the second valve to supply the second fluid to the predetermined section.

7. The motor system according to claim 1, wherein the first fluid is oil, and the second fluid is CO₂.

8. The motor system according to claim 2, wherein the first fluid is oil, and the second fluid is CO₂.

9. The motor system according to claim 3, wherein the first fluid is oil, and the second fluid is CO₂.

10. The motor system according to claim 4, wherein the first fluid is oil, and the second fluid is CO₂.

11. The motor system according to claim 5, wherein the first fluid is oil, and the second fluid is CO₂.

12. The motor system according to claim 6, wherein the first fluid is oil, and the second fluid is CO₂.
